(19) United States
(12) Patent Application Publication
(10) Pub. No.: US 2020/0246766 A1
(43) Pub. Date: Aug. 6, 2020

(54) Vessel and mixer

(71) Applicants: Douglas Teeter, Paradise, CA (US); Donald Flaner, Orland, CA (US)

(72) Inventors: Douglas Teeter, Paradise, CA (US); Donald Flaner, Orland, CA (US)

(21) Appl. No.: 16/263,166

(22) Filed: Jan. 31, 2019

(51) Int. Cl. B01F 7/00; B01F 3/12; B01F 3/14; B01F 7/16

(52) U.S. Cl. CPC B01F 7/00291; B01F 3/1221; B01F 3/1271; B01F 2215/005; B01F 7/1695; B01F 7/1605; B01F 2215/0422; B01F 3/14

(57) ABSTRACT

This invention is directed toward a mixing vessel and mixer where the design of the mixer and mixing vessel allow the mixer to reach all the cracks and crevices of the mixing vessel. The mixer also has two opposing openings with mixing vanes that facilitate turbulence and blending through a strong centrifugal flow. The mixer has unbroken or minimally broken surfaces for grinding/shearing lumps into a smooth, lump-free paste.

### CROSS REFERENCE TO RELATED APPLICATIONS

None

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of devices used for mixing drywall paste, paint, another other viscous liquids, and more specifically, to an elongated mixing vessel with semi-circular ends and a taper mixer with unique mixing surfaces, openings and vanes.

### Brief Description of Invention

In a preferred embodiment of the invention, the mixing vessel has a “racetrack” shape with semi-circular ends such that the mixer can be moved back and forth through the mixing vessel to thoroughly mix any combination of the drywall paste, powder, water, low-viscosity liquids, paint, or other viscous liquids. Because the mixer has a circular shape, it thoroughly cleans and mixes any dry residue from the ends of the mixing vessel. The mixing vessel is angled out from the bottom, leaving greater than a 90 degree angle between the sides and the bottom, thereby further decreasing the chances that any dry matter will get stuck in the crevice.

In a preferred embodiment of the invention, the mixer is fluted outward from its base at an angle similar to that of the mixing vessel, thereby removing any areas of the mixing vessel that are not touched by the mixer. In an alternate embodiment, the mixer is not fluted outward such that it can perform its function in a bucket with vertical sides. In the preferred embodiment used for purposes of illustration, the mixer is roughly conical with a flat bottom, and can be attached to a standard electric drill or impact driver by a shaft. There are two opposing openings in the mixer which include mixing vanes which facilitate turbulence for liquid mixing and for the initial blending of liquid and powder (and/or paste). The mixing vanes have both a leading angle and a following angle which serve to thoroughly mix either a powder/liquid or powder/paste combination, or to stir a viscous liquid such as paint. The mixer has two opposing unbroken surfaces for grinding/shearing lumps into a smooth lump free paste.

Viscous liquids are essential to many parts of the construction industry. Drywall paste, stucco, and paint are but a few of the viscous liquids that are used in construction. Thus, the ability to thoroughly, quickly and effectively mix the various components into a final product is essential to performing quality work.

The prior art has several examples of attempts to resolve this problem. There are square-cornered mixing vessels in which the dry components tend to accumulate in the corners, requiring a user to physically mix this area with a spatula or other manual device. There are also round mixing vessels where the sides meet at a 90 degree angle to the bottom, thereby creating a crevice between the sides and the bottom in which dry components will also accumulate.

Mixers are also known in the art. Many of these comprise a long shaft with some sort of two- or three-dimensional mixer at the end, often called “eggbeater mixers”, which function very much like the beaters on a kitchen mixer.

There are even double paddle and planetary mixers which tend to be expensive more difficult to clean and require transfer to a “mud pan” (rectangular) for efficient loading of paste onto a drywall knife (blade)

However, none of this prior art can provide an economical means of effectively mixing both liquid, paste and power mixtures in a manner that does not require a user of the invention to physically reach into the mixing vessel and scrape off accumulations of dry mix or areas in which a liquid has settled or directly be ready to use for loading of a drywall knife.

Thus, there has existed a long-felt need for a mixing vessel and mixer that can work to minimize areas in which dry powder congregates and thoroughly mix any liquid, paste powder combinations, or viscous liquids.

The current invention provides just such a solution by having a mixing vessel with sloped sides, where the angle of the slope is matched by the angle of the conical mixer. The racetrack-shaped mixing vessel has semi-circular ends which allow the mixer to effectively reach all the potential “corners” of the mixing vessel such that there are no “pockets” for dry material to accumulate. The mixer also has two opposing openings with mixing vanes that facilitate turbulence and blending through a strong centrifugal flow. The mixer also has two side surfaces and a bottom surface to grind and shear unmixed lumps. As the mixer is moved back and forth along the vessel, lumps are ground between the sides of the mixer and the sides of the vessel. Because the mixer has a smaller diameter than the width of the mixing vessel, there is not a problem with material backing up and overflowing the sides of the mixing vessel. Since the height of the mixer is less than the height of the mixing vessel, there is similarly no problem with material backing up as the mixer is moved from one end of the mixing vessel to the other.

In an alternate embodiment, the mixer has vertical sides to effectively mix viscous liquids and powder/liquid mixtures in a bucket with vertical sides, such as those commonly found storing paint, and “Home Depot buckets”. In this embodiment, the mixer is used in a vessel with vertical sides, which allow the mixer to effectively reach all the potential “corners” of the mixing vessel such that there are no “pockets” for dry material to accumulate. The mixer also has two opposing openings with mixing vanes that facilitate turbulence and blending through a strong centrifugal flow. The mixer also has two side surfaces and a bottom surface to grind and shear unmixed lumps. Because the mixer has a smaller diameter than the width of the mixing vessel, there is not a problem with material backing up and overflowing the sides of the mixing vessel. Since the height of the mixer is less than the height of the mixing vessel, there is similarly no problem with material backing up as the mixer is moved from one side of the mixing vessel to the other.

### OBJECTS OF THE INVENTION

It is therefore an object of the present invention to provide a vessel designed without any pockets or corners into which dry powder can accumulate.

Another object of the invention is to provide a vessel with sloped sides that mate with the sloped sides of the mixing vessel such that there are no dry pockets and there is complete blending along with maximum tool contact and facilitates scooping out material to be applied.

Additional objects of the invention include providing a mixer with mixing vanes and surfaces to facilitate turbulence and blending.

A further object of the invention is to provide a combination of a mixing vessel and a mixer that can thoroughly and effectively mix a viscous liquid, paste and powder or any combination in an economical, efficient and ready to use manner.

### STATEMENT OF THE INVENTION

A preferred embodiment of the invention calls for a device for mixing viscous liquids and dry powder/liquid mixtures, consisting of a mixer, comprising a stem, a mixer bottom, a mixer side, two openings, a mixer side angle, a mixer diameter, a mixer height, a mixing vane, where the mixing vane comprises a leading angle and a following angle, a mixer top ring, and an anti-chatter projection, a vessel, comprising two vessel sides, two vessel ends, a vessel width, a vessel height, and a vessel side angle, where, the stem is attached to the mixer bottom, where the mixer diameter is less than the vessel width, where the mixer height is less than the vessel height, where, as the mixer is moved through the vessel, the mixer diameter and the mixer height allow the substance to move over and around the mixer and does not escape over the two vessel sides and two vessel ends of the vessel, where, the stem has a stem top, and where the step top has four or more sides, and where the four or more sides are flat, and where the stem top has a stem top diameter, and where the stem top diameter is less than ½ inch, such that a standard power drill can accept the stem top into a chuck of the standard power drill or impact driver, where, the mixer side angle is equal to the vessel side angle, where the two vessel ends are semi-circular, where the mixer can be rotated by the standard power drill, where the mixer as it rotates causes a substance to be pulled in through the two openings, beaten by the mixing vanes, ground at an interface between the mixer sides and bottom, and any one of the two vessel sides and two vessel ends, and where the leading angle and the following angle create a mixture current, where the mixture current flows through the mixer and facilitate the mixing of the substance, and where the mixer can be placed at any part of the two vessel sides and the two vessel ends and maintain the interface between the mixer side and any one of the two vessel sides and two vessel ends, and where the anti-chatter projection and the mixer top ring provide stability and strength to the mixer.

Another preferred embodiment calls for the mixer side angle to be equal to the vessel side angle, and specific alternate embodiments of both the mixer side angle and the vessel side angel being 90 degrees vertical, and 15 degrees sloped, are contemplated.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention. For example, which the general concept of a drywall paste mixer is used for purposes of illustration, the technology described in this patent application and the theories behind would work equally well with paint mixing, stucco mixing, grout mixing, and a variety of other uses.

### BRIEF DESCRIPTION OF THE FIGURES

One preferred form of the invention will now be described with reference to the accompanying drawings.

FIG. 1 is a perspective view of the mixing vessel and mixer.

FIG. 2 is a top view of the mixing vessel and mixer.

FIG. 3 is a side view of the mixing vessel and mixer.

FIG. 4 is cross sectional view of the mixer in the mixing vessel, showing how the mixer has a lower height than the mixing vessel and how the edges of the mixer mate with the inner edges of the mixing vessel.

FIG. 5 is a perspective view of the mixer, showing its basic components.

FIG. 6 is a side view of the mixer with one of its openings facing the viewer.

FIG. 7 is a side view of the mixer turned 90 degrees from the figure in FIG. 6, showing a side view of the openings.

FIG. 8 is a bottom view of the mixer.

FIG. 9 is a top view of the mixer.

FIG. 10 is a cross-sectional view of the mixer.

FIG. 11 shows the shaft extension on the mixer.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

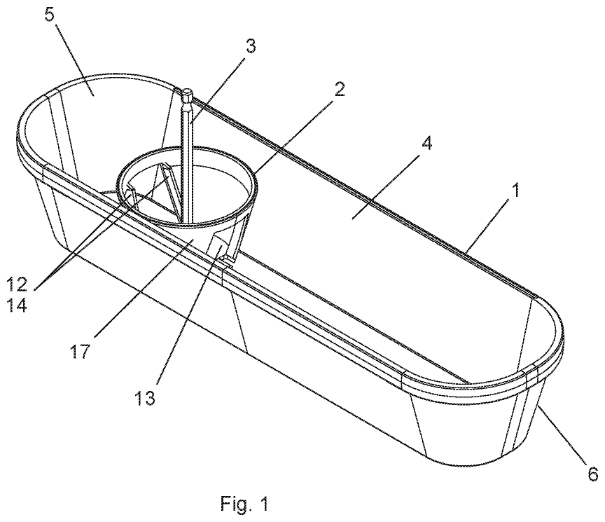

FIG. 1 is a perspective view of the mixing vessel and mixer. The mixing vessel, referred to generally as 1 is a long, racetrack-shaped container with a sloped side 6 and end sections 5 that are shaped like semi-circles. This allows the round mixer to mate with both the sides 4 and ends 5 of the mixing vessel, thereby removing the “pockets” found in the prior art which prevented effective mixing. Because the sides 4 of the vessel are higher than the mixer 2, there is not a problem with the mixer causing material to back up and spill over the sides 4 or ends 5 of the mixing vessel. There are two opposing openings 13 in the mixer which include mixing vanes 12 and 14 which facilitate turbulence for liquid mixing and for the initial blending of liquid and powder (and/or paste). The mixing vanes have both a leading angle and a following angle which serve to thoroughly mix either a powder/liquid or powder/paste combination, or to stir a viscous liquid such as paint. The mixer has two opposing unbroken or minimally broken surfaces 17 and bottom for grinding/shearing lumps into a smooth, lump-free paste.

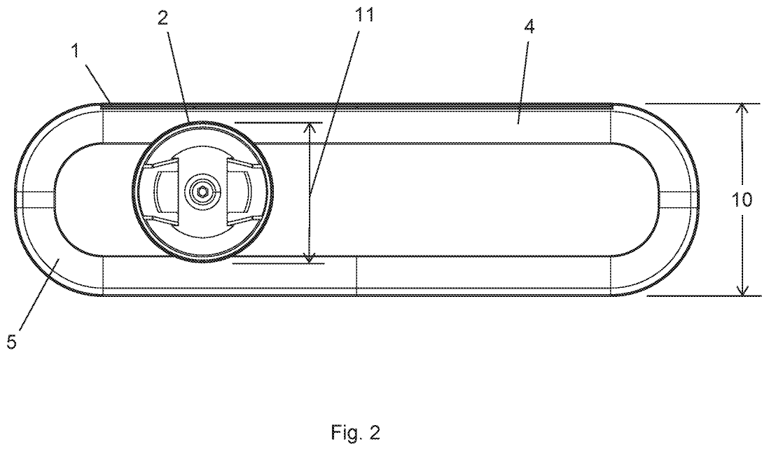

FIG. 2 is a top view of the mixing vessel and mixer. The vessel has a vessel width 10, which is greater than the mixer width 11, such that as the mixer is being moved back and forth along the mixing vessel, the liquid and or paste can move around either side of the mixer, such that there is no problem with the mixer forcing a backup of material over and outside the sides 4 or ends 5 of the vessel.

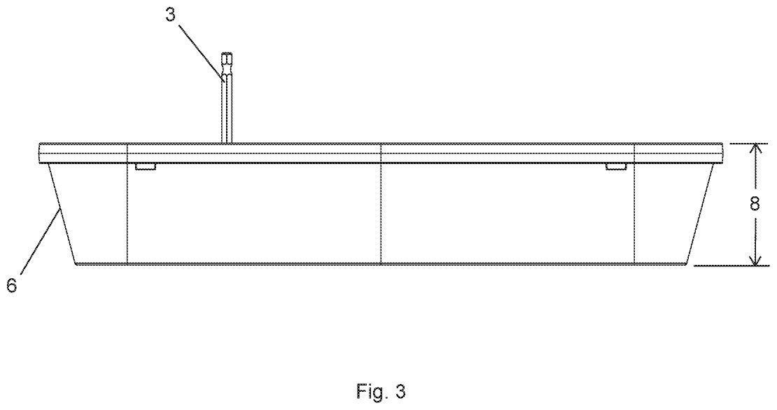

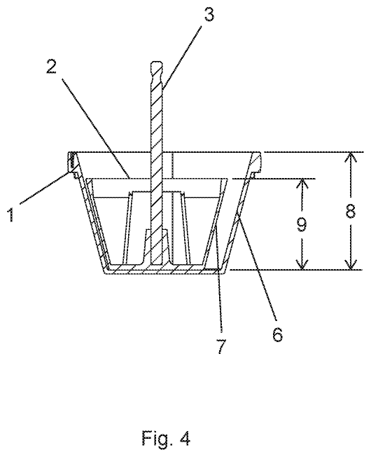

FIG. 3 is a side view of the mixing vessel and mixer. This figure shows that the vessel height 8 is larger than the height of the mixer, which is obscured by the sides of the vessel other than the stem 3 of the mixer. Therefore, as the mixer is being moved forward and back through the vessel, any liquid can flow either around or over the mixer, thereby preventing any problems with spillage. This view also shows the sloped sides 6 of the vessel. The angle of the slope mates with the angle of the mixer (7 in FIG. 4).

FIG. 4 is cross sectional view of the mixer in the mixing vessel, showing how the mixer has a lower height than the mixing vessel and how the edges of the mixer mate with the inner edges of the mixing vessel. The mixer height 9 is less than the vessel height 8, such that liquid can flow over the mixer to avoid backup and spillage problems. The mixer 2 has a smaller width than does the vessel 1, so that liquid can move around the sides of the mixer to avoid the same overflow and spillage problems. The mixer side angle 7 is the same angle as the vessel side angle 6. The stem 3 is attached to the bottom of the mixer.

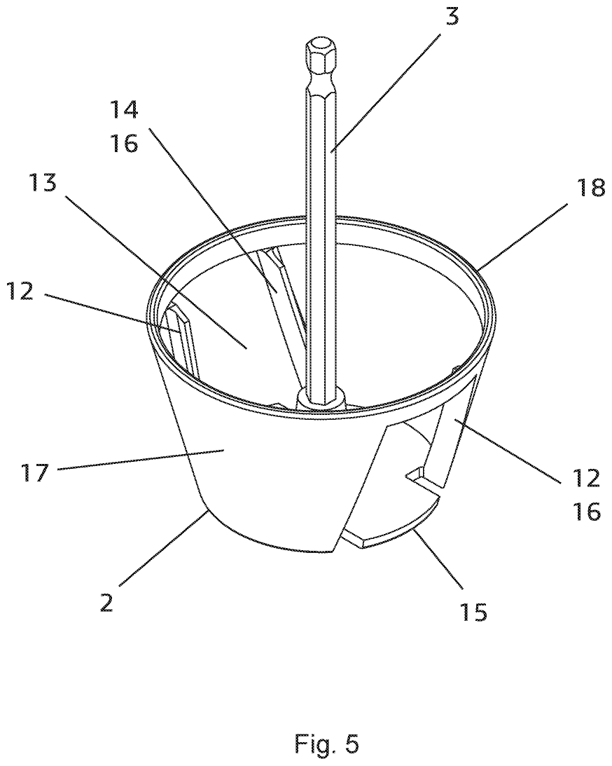

FIG. 5 is a perspective view of the mixer, showing its basic components. A stem 3 is used to connect the mixer to any standard electric drill. At opposing sides of the mixer are two openings 13. Having the two openings 13 directly opposite each other allows for reverse operations for faster mixing/blending. Each opening has a mixing vane, generally described by 12 and 14, with a mixing vane leading edge and a mixing van trailing edge respectively. The opening 13 allows the liquid and the powder to interact with the mixing vanes by creating strong centrifugal flow down through the mixer head when it is fully submerged. The opening 13 also facilitates liquid mixing and initial powder/liquid blending by forcing these substances to interact with the mixing vanes 12. The mixer has a complete top ring 18, which serves to not only solidify and strengthen the mixer, and two anti-chatter projections 15. Both top ring and projections serve to reduce chatter, vibration, and splatter.

The mixing vane 12 facilitates turbulence for liquid mixing and initial powder, paste, and liquid blending. The mixing vane angle 16 initiates centrifugal flow through the mixer and creates turbulence. It also facilitates the mixing of powder/liquid combinations as it drives material down into the vessel.

The mixing vane following angle 14 assists with liquid mixing as it creates turbulence in the flow of material, and removes material from inside the mixer, thereby assisting with blending the material thoroughly.

At opposing sides of the mixer are unbroken or minimally broken surfaces 17. Each surface 17 and mixer bottom allows the liquid and powder or paste with dry lumps to be ground and sheared thus incorporated into a smooth lump free paste. As mixer is moved around vessel both centrifugal and rotational forces draw the liquid, powder and paste into the grinding/shear zones. Paste clings to outside of mixer thus drawing more into grinding/shear zones. It is well known in the industry that when a dry, fine material is mixed with a liquid such as water, the dry material becomes coated with an outside layer of moist material and is nearly impossible to “break up” using only a stirring action. Thus, these lumps must be either cut or ground into smaller and smaller pieces such that they eventually become the desired end product. The prior art does not provide us with a reasonable way in which these lumps can be ground into the final paste, but the current invention does so due to its novel configuration. The current invention provides an unbroken surface at the bottom and sides of the mixer, which interact against a stationary surface. This will draw in and break up, through shearing and grinding, lumps and incorporate them into the final, desired end slurry or paste. The centrifugal force created by the vanes and openings creates “mixing channels” that ensure that any lumps are eventually forced through all of the various mixing, grinding and shearing components of the invention.

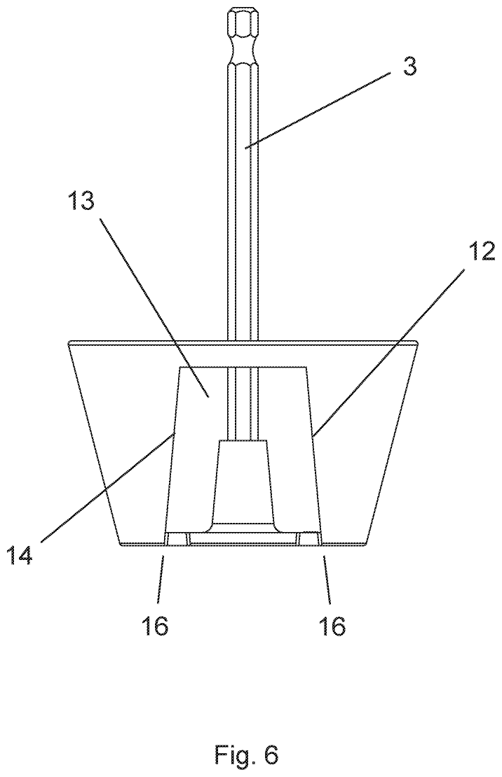

FIG. 6 is a side view of the mixer with one of its openings facing the viewer. The opening 13 is opposite an opening on the other side of the stem 3. The mixing vanes are symmetrical on each side of the opening, such that the mixer is balanced and can be run in reverse. The mixing vane angle 16, described in FIG. 5, is apparent here.

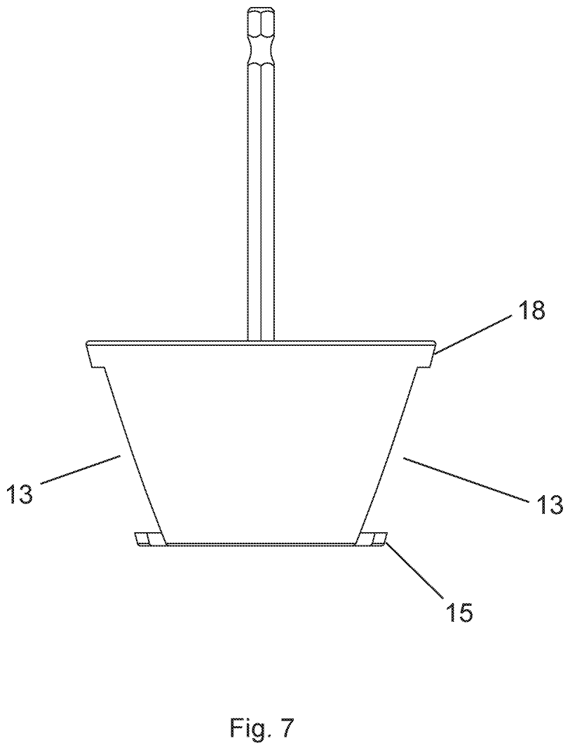

FIG. 7 is a side view of the mixer turned 90 degrees from the figure in FIG. 6, showing a side view of the openings 13 as well as the anti-chatter projection and mixer top ring, 15 and 18 respectively.

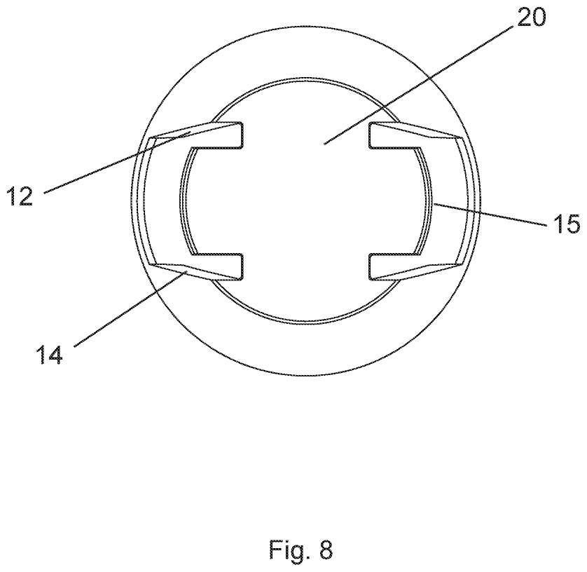

FIG. 8 is a bottom view of the mixer. This figure shows the mixing vane leading angle 12 and the mixing vane following angle 14. This figure also shows below each opening the anti-chatter projection 15, which maintains a near continuous bottom diameter and the mixer bottom 20.

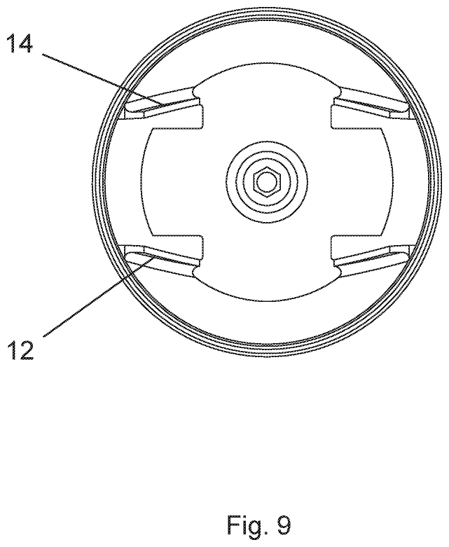

FIG. 9 is a top view of the mixer.

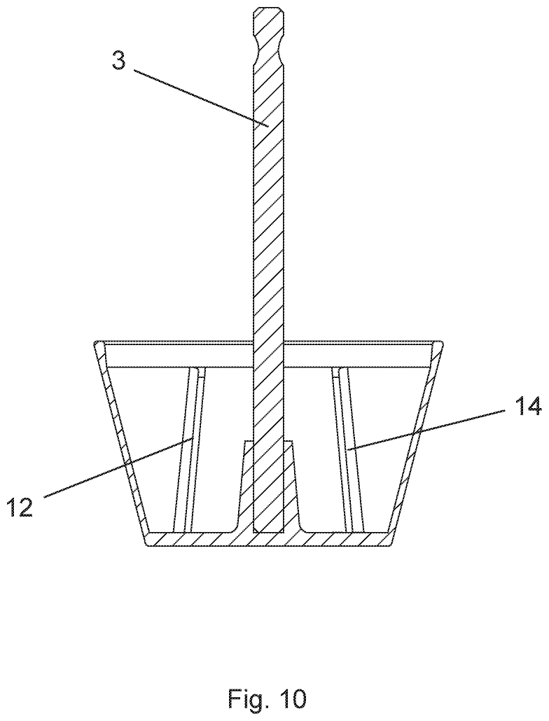

FIG. 10 is a cross-sectional view of the mixer.

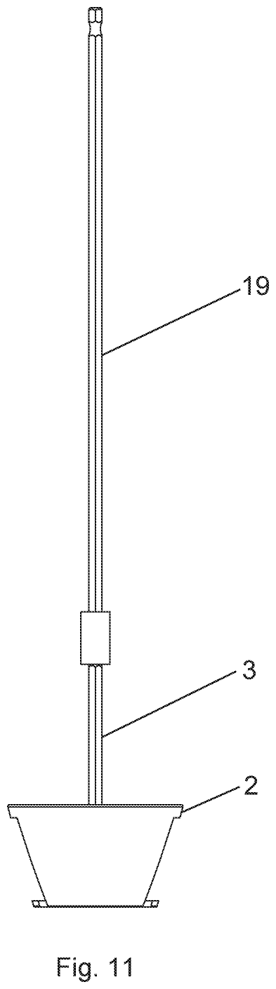

FIG. 11 is a view of the mixer with the shaft extension 19 installed on the mixer. The shaft extension permits mixer to reach the bottom of deep containers.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### REFERENCE NUMBERS USED

1. Vessel, generally.
2. Mixer, generally.
3. Stem
4. Vessel sides
5. Vessel ends
6. Vessel side angle
7. Mixer side angle
8. Vessel height
9. Mixer height
10. Vessel width
11. Mixer width
12. Mixing vane leading
13. Mixer opening
14. Mixing vane following
15. Anti-chatter projection
16. Mixing vane angle
17. Mixer sides
18. Mixer top ring
19. Shaft extension
20. Mixer bottom

That which is claimed:

1. A device for mixing viscous liquids and dry powder/liquid mixtures, consisting of:
a mixer, comprising a stem, a mixer bottom, a mixer side, where the mixer side comprises two openings, a mixer side angle, a mixer diameter, a mixer height, a mixing vane, where the mixing vane comprises a leading angle and a following angle, a mixer top ring, and an anti-chatter projection,
a vessel, comprising two vessel sides, a vessel bottom, two vessel ends, a vessel width, a vessel height, and a vessel side angle,
where, the stem is attached to the mixer bottom, where the mixer diameter is less than the vessel width, where the mixer height is less than the vessel height,
where, as the mixer is moved through the vessel, the mixer diameter and the mixer height allow the substance to move over and around the mixer and does not escape over the two vessel sides and two vessel ends of the vessel,
where, the stem has a stem top, and where the step top has four or more sides, and where the four or more sides are flat, and where the stem top has a stem top diameter, and where the stem top diameter is less than ½ inch, such that a standard power drill can accept the stem top into a chuck of the standard power drill or impact driver,
where, the mixer side angle is equal to the vessel side angle, where the two vessel ends are semi-circular,
where the mixer can be rotated by the standard power drill, where the mixer as it rotates causes a substance to be pulled in through the two openings, beaten by the mixing vane, ground at an interface between the mixer side and vessel bottom and any one of the two vessel sides and two vessel ends, and where the leading angle and the following angle create a mixture current, where the mixture current flows through the mixer and facilitate the mixing of the substance, and where the mixer can be placed at any part of the two vessel sides and the two vessel ends and maintain the interface between the mixer side and any one of the two vessel sides and two vessel ends,
and where the anti-chatter projection and the mixer top ring provide stability and strength to the mixer.

2. A device for mixing viscous liquids and dry powder/liquid mixtures, comprising:
a mixer, comprising a stem, a mixer bottom, a mixer side, two openings, a mixer side angle, a mixer diameter, a mixer height, a mixing vane, where the mixing vane comprises a leading angle and a following angle, a mixer top ring, and an anti-chatter projection,
a vessel, comprising two vessel sides, a vessel bottom, two vessel ends, a vessel width, a vessel height, and a vessel side angle.

3. The device of claim 2, where, the stem is attached to the mixer bottom, where the mixer diameter is less than the vessel width, where the mixer height is less than the vessel height.

4. The device of claim 3, where, where, the stem has a stem top, and where the step top has four or more sides, and where the four or more sides are flat, and where the stem top has a stem top diameter, and where the stem top diameter is less than ½ inch, such that a standard power drill can accept the stem top into a chuck of the standard power drill.

5. The device of claim 4, where, the mixer side angle is equal to the vessel side angle

6. The device of claim 5, where the mixer side angle is 90 degrees vertical.

7. The device of claim 6, where the vessel side angle is 90 degrees vertical, and where the two vessel ends are semi-circular.

8. The device of claim 4, where the mixer side angle is 15 degrees

9. The device of claim 8, where the vessel side angle is 15 degrees.

10. The device of claim 9, where the two vessel ends are semi-circular.

11. The device of claim 10, where, as the mixer is moved through the vessel, the mixer diameter and the mixer height allow the substance to move over and around the mixer and does not escape over the two vessel sides and two vessel ends of the vessel.

12. The device of claim 11, where the mixer can be rotated by the standard power drill, where the mixer as it rotates causes a substance to be pulled in through the two openings, beaten by the mixing vane, ground at an interface between the mixer side and bottom and any one of the two vessel sides and two vessel ends, and where the leading angle and the following angle create a mixture current, where the mixture current flows through the mixer and facilitate the mixing of the substance, and where the mixer can be placed at any part of the two vessel sides and the two vessel ends and maintain the interface between the mixer side and any one of the two vessel sides and two vessel ends.

13. The device of claim 12, where, the anti-chatter projection and the mixer top ring provide stability and strength to the mixer.

14. The device of claim 5, where, the mixer side angle is between 10 and 90 degrees, the vessel side angle is between 10 and 90 degrees, and where the two vessel ends are semi-circular.

15. A device for mixing viscous liquids and dry powder/liquid mixtures, comprising: a mixer, comprising a stem, a mixer bottom, a mixer side, two openings, a mixer side angle, a mixer diameter, a mixer height, a mixer top ring, and an anti-chatter projection.

16. The device of claim 15, additionally comprising a mixing vane, where the mixing vane comprises a leading angle and a following angle.

17. The device of claim 16, where the anti-chatter projection and the mixer top ring provide stability and strength to the mixer, where the stem is attached to the mixer bottom, where, the stem has a stem top, and where the step top has four or more sides, and where the four or more sides are flat, and where the stem top has a stem top diameter, and where the stem top diameter is less than ½ inch, such that a standard power drill can accept the stem top into a chuck of the standard power drill.

18. The device of claim 17, where the mixer side angle is 90 degrees vertical.

19. The device of claim 17, where the mixer side angle is between 10 and 20 degrees, and, where the vessel side angle is between 10 and 20 degrees.

20. The device of claim 17, additionally comprising a vessel, where the vessel comprises two vessel sides, two vessel ends, a vessel width, a vessel height, and a vessel side angle, where the two vessel ends are semi-circular, where the mixer diameter is less than the vessel width, where, as the mixer is moved through the vessel, the mixer diameter and the mixer height allow the substance to move over and around the mixer and does not escape over the two vessel sides and two vessel ends of the vessel, where the mixer can be rotated by the standard power drill, where the mixer as it rotates causes a substance to be pulled in through the two openings, beaten by the mixing vane, ground at an interface between the mixer side and a vessel bottom and any one of the two vessel sides and two vessel ends, and where the leading angle and the following angle create a mixture current, where the mixture current flows through the mixer and facilitate the mixing of the substance, and where the mixer can be placed at any part of the two vessel sides and the two vessel ends and maintain the interface between the mixer side and any one of the two vessel sides and two vessel ends, where, the anti-chatter projection and the mixer top ring provide stability and strength to the mixer.
